(19) United States
(12) Patent Application Publication
(10) Pub. No.: US 2025/0004493 A1
(43) Pub. Date: Jan. 2, 2025

(54) Voltage Regulation

(71) Applicant: Nordic Semiconductor ASA, Trondheim (NO)

(72) Inventors: Ola Bruset, Trondheim (NO); Samuli Antti Hallikainen, Oulu (FI)

(73) Assignee: Nordic Semiconductor ASA, Trondheim (NO)

(21) Appl. No.: 18/759,211

(22) Filed: Jun. 28, 2024

(30) Foreign Application Priority Data
Jun. 30, 2023 (GB) 2310056.3

(51) Int. Cl. G05F 1/575

(52) U.S. Cl. CPC G05F 1/575

(57) ABSTRACT

A method and circuitry for voltage regulation is provided. The circuitry has a voltage regulation portion and a control portion. The voltage regulation portion has a regulation mode and a bypass mode, and when the voltage regulation portion is in the bypass mode, it outputs an unregulated voltage received from a power supply. When the voltage regulation portion is in the regulation mode and the received unregulated voltage is greater than a received reference voltage, the voltage regulation portion regulates the unregulated voltage to output a predetermined regulated voltage. The control portion compares a feedback voltage based on the output from the voltage regulation portion to a reference voltage. When the voltage regulation portion is in the regulation mode, the control portion, in response to determining that the feedback voltage does not exceed the reference voltage, switches the voltage regulation portion into the bypass mode.

### BACKGROUND OF THE INVENTION

This invention relates to circuitry and a method for regulating a voltage from a power supply to output a reduced voltage which circuit components in a system-on-chip (SOC) circuit can be safely exposed to.

When SOCs are powered by one or more battery cells, this can result in a variable magnitude of supply voltage. When batteries are new, they can supply a voltage higher than their rated level, and when they age, they can supply a voltage which is less than their rated level. This can happen over a single charging cycle and over the lifetime of the battery, which may comprise many thousands of charging cycles.

Some other circuit components can show severe ageing when operated at supply voltages that are as high as, or nearly as high as, their rated operational voltage. Therefore, it is beneficial to protect circuit components from being exposed to voltages greater than a determined magnitude, beyond which unacceptable ageing may occur.

It is known to use voltage regulators to regulate the magnitude of a voltage down from a higher level, to a lower voltage for the rest of a circuit. The present invention aims to provide an improved way of regulating a voltage from a power supply.

### SUMMARY OF THE INVENTION

From a first aspect, the invention provides voltage regulation circuitry comprising:
a voltage regulation portion comprising a voltage regulator and having a regulation mode and a bypass mode, wherein the voltage regulation portion is configured:
when the voltage regulation portion is in the bypass mode, to output an unregulated voltage received from a power supply; and
when the voltage regulation portion is in the regulation mode and the received unregulated voltage is greater than a received reference voltage, to regulate the unregulated voltage to output a predetermined regulated voltage; and the voltage regulation circuitry further comprising a control portion configured to:
compare a feedback voltage based on the output from the voltage regulation portion to a reference voltage; and
when the voltage regulation portion is in the regulation mode, in response to determining that the feedback voltage does not exceed the reference voltage, switch the voltage regulation portion into the bypass mode.

From a second aspect, the invention provides a method of voltage regulation comprising:
using a voltage regulation portion comprising a voltage regulator to:
   when the voltage regulation portion is in a bypass mode, output an unregulated voltage received from a power supply; and
   when the voltage regulation portion is in a regulation mode and the received unregulated voltage is greater than a received reference voltage, regulate the unregulated voltage to output a predetermined regulated voltage; and
using a control portion of circuitry to:
   compare a feedback voltage based on the output from the voltage regulation portion to a reference voltage; and
   when the voltage regulation portion is in the regulation mode, in response to determining that the feedback voltage does not exceed the reference voltage, switch the voltage regulator into a bypass mode.

Thus it will be seen that, in accordance with at least embodiments of the invention, the voltage output from the voltage regulation portion of the voltage regulation circuitry can be controlled by automatically switching the voltage regulation portion into different modes, in dependence on the comparison of its output voltage to a threshold. By switching the voltage regulation portion into the bypass mode, the voltage regulation portion does not continue to regulate the magnitude of the supply voltage down to a regulated voltage when the supply voltage would not exceed the predetermined regulated voltage. Switching the voltage regulation portion into bypass mode when regulation is not required may advantageously reduce power consumption of the voltage regulation circuitry. This may improve upon naïve approaches, where supplying a voltage through a voltage-regulator would keep the voltage regulator “on”, even when the supply voltage falls below the predetermined regulated voltage level.

In a set of embodiments, the control circuitry is configured, when the voltage regulation portion is in bypass mode, in response to determining that the feedback voltage exceeds the reference voltage, to switch the voltage regulation portion into the regulation mode. Thus, advantageously, the voltage regulation circuitry can automatically be switched back into the regulation mode to output the predetermined regulated voltage when it is detected that the supply voltage rises above the predetermined regulated level.

In some embodiments the voltage regulation circuitry is provided as part of an integrated circuit on a system-on-chip. The system on chip may comprise other components and circuitry, such as a CPU, a radio component, a DC-DC Buck Converter and a memory portion.

In some embodiments, the power supply is a DC power supply. The DC power supply may be provided by a battery. The battery may comprise one or more cells, which may each be rated to provide a nominal DC voltage. Typically, the voltage provided by a battery will vary across its lifetime. The supplied voltage may be higher than the rated nominal DC voltage when the battery is new, and the supplied voltage may decay as the battery is used. This decay may happen over a single charging cycle, and may occur over the lifetime of the battery, which may comprise many thousands of charging cycles.

In some embodiments, the voltage regulator is a DC linear voltage regulator. The DC linear voltage regulator may be a low drop-out voltage regulator (LDO). A linear voltage regulator typically comprises an error amplification circuit portion, a gate-drive circuit portion circuitry and a pass transistor. When the voltage regulation portion is in the regulation mode, the voltage regulator may be switched on. When the voltage regulator is switched on, the voltage regulator regulates the unregulated voltage received from the power supply to output the predetermined regulated voltage. In this way, when the voltage regulator is exposed to a supply voltage which is higher than a predetermined safe level for the rest of the circuit, the supply voltage may be regulated down to a safe level by the voltage regulator. This may be advantageous where portions of circuitry in a system-on-chip have better operational longevity at a lower voltage than the voltage which is supplied by the power supply of the system-on-chip. This may be because the circuit components are rated at a lower voltage than is provided by the power supply, or because exposing the circuit components to voltages at the upper end of the rated voltage range can cause premature ageing of the components.

In a set of embodiments, in the bypass mode, the control portion is configured to switch the voltage regulator in the voltage regulation circuitry off, and pass the unregulated voltage received from the power supply through to the output of the voltage regulation portion. In some embodiments, in the bypass mode, all the components of the voltage regulation circuitry are turned off, except for the control circuitry. This advantageously minimises the current consumption in the bypass mode. The current consumption of the voltage regulation circuitry in the bypass mode may be as low as of the order of tens of nA. As will be appreciated by those skilled in the art, switching components off may be considered to correspond to providing no power thereto, or so little power that they do not function.

In a set of embodiments where the voltage regulation circuitry is provided as part of an integrated system-on-chip, the voltage regulation circuitry is configured to start in the bypass mode when the system-on-chip undergoes an analog reset (i.e. is re-booted and powered-on). The Applicant has appreciated that when the system-on-chip is starting up, the voltage references and bias currents used by the voltage regulation circuitry may not yet be available. Therefore, the voltage regulation circuitry would not be able to operate effectively in the regulation mode. The output voltage of the voltage regulation portion may be momentarily higher than a predetermined regulated voltage. Thus, in some embodiments, the control circuitry is configured, when the voltage regulation circuitry is in the bypass mode following an analog reset, to switch the voltage regulation portion to the regulation mode after a predetermined time period has elapsed since reset. The Applicant has appreciated that when the predetermined time period is kept very short (e.g. only up to 1 ms), the exposure of the system-on-chip to a voltage higher than the predetermined regulated level does not result in unacceptable degradation of the circuit components.

In a set of embodiments, the voltage regulation circuitry has a low-power mode and a high-power mode. The high-power mode may provide more accurate voltage regulation, better transient behaviour and lower noise compared to the low-power mode, but may consume more power. In some embodiments, the voltage regulation circuitry is configured to operate in the high-power mode only when the rest of the system-on-chip is operating in a high-power mode e.g. when the CPU is running, or a radio component is operating. In a set of embodiments where the voltage regulation circuitry is provided as part of an integrated system-on-chip, the voltage regulation circuitry is configured to operate in the high-power mode when the high-frequency digital clock of the system-on-chip is running, and otherwise is configured to operate in the low-power mode. The high frequency clock is typically enabled when running a CPU, radio component, or other high-power consuming components in the system-on chip. The Applicant has appreciated that only operating the voltage regulation circuitry in a high-power regulation mode when the rest of the system-on-chip is using other high-power components can advantageously save power when more accurate voltage regulation is not required. In a set of embodiments, the voltage regulation portion has an idle mode. When the voltage regulation portion is in the idle mode, the voltage regulation portion may be configured such that no power is provided to the voltage regulator, and the unregulated voltage received from the power supply is not passed through to the output of the voltage regulation portion. In the idle mode, control portion may thus be configured to switch the voltage regulator in the voltage regulation portion off, without enabling the bypass mechanism between the power supply and the output of the voltage regulation portion.

Configuring the voltage regulation circuitry such that it has an idle mode may advantageously enable power to be saved when the rest of the system-on-chip is operating in a low-power mode. When the rest of the system-on-chip is operating in a low-power mode, the quality of the voltage regulation may be less critical.

In embodiments where the voltage regulation portion has an idle mode, the control circuitry may be configured to, when the voltage regulation circuitry is in a low-power mode and the voltage regulation portion is in the regulation mode:
in response to determining that the feedback voltage exceeds the reference voltage, switch the voltage regulation circuitry into the idle mode.

In the idle mode, the power supply is disconnected from the output of the voltage regulation portion by turning off the voltage regulation portion, without enabling the bypass mode. The output voltage of the voltage regulation portion will therefore decay over time. In embodiments where the voltage regulation portion has an idle mode, the control circuitry may thus be further configured to detect when the voltage regulation circuitry needs to be activated again, in order to refresh the output voltage of the voltage regulation portion.

Thus, in some embodiments, the control circuitry may be configured, when the voltage regulation portion is in the idle mode:
in response to determining that the feedback voltage does not exceed the reference voltage, to switch the voltage regulation portion into the regulation mode.

The control circuitry may be configured to keep the voltage regulation portion in the regulation mode for a predetermined period of time after switching the voltage regulation portion into the regulation mode from the idle mode. Switching the voltage regulation portion into a regulation mode for a predetermined period of time when the voltage regulation circuitry is in the low-power mode may be referred to as switching the voltage regulation portion into a low-power refresh mode.

The control circuitry may subsequently, at the end of said predetermined period of time (i.e. the end of the low-power refresh mode), be configured to switch the voltage regulation portion back into the idle mode in response to determining that the feedback voltage exceeds the reference voltage. This is expected in the scenario where the unregulated voltage from the power supply exceeds the predetermined regulated voltage. If the feedback voltage does not exceed the reference voltage at the end of the predetermined period of time, the control circuitry may be configured to switch the voltage control portion into bypass mode. This is expected in the scenario where the unregulated voltage from the power supply is lower than the predetermined regulated voltage. Thus, even when the voltage regulation circuitry is in a low-power mode, the output of the voltage regulation portion can be controlled such that the voltage regulation portion is switched into bypass mode when the power supply decays.

In a set of embodiments, the control circuitry comprises a comparator, wherein the comparator is configured to:
receive the feedback voltage based on the output from the voltage regulation portion and the reference voltage; and
output a signal indicating whether the feedback voltage exceeds the reference voltage.

In a set of embodiments, the control circuitry comprises digital control logic. The digital control logic may be configured to receive the output signal indicating whether the feedback voltage exceeds the reference voltage from the comparator, and switch the voltage regulation circuitry between the bypass mode and the regulation mode in dependence on the received comparator output signal.

In a set of embodiments, the reference voltage may correspond to the predetermined regulated voltage. The predetermined regulated voltage may be programmable, and the reference voltage required to ensure that the switching from the bypass mode to the regulation mode occurs.

In a set of embodiments, the voltage regulation circuitry further comprises a reference voltage generator. The reference voltage generator may be configured:
when the voltage regulation circuitry is operating in a high-power mode, to output a reference voltage using a high-power current source; and
when the voltage regulation circuitry is operating in a low-power mode, to output a reference voltage using a low-power current source.

When the voltage regulation circuitry is operating in a low-power mode, the reference voltage generator may be configured to generate the reference voltage using references which are always on in another part of the system-on-chip. When the voltage regulation circuitry is operating in a high-power mode, the voltage generator may be configured to generate the reference voltage using a biasing current which is only available when other high-power circuit components on the system-on-chip are active.

In a set of embodiments, the voltage regulation circuitry further comprises a feedback divider portion. The feedback divider portion may be configured to:
receive the output voltage of the voltage regulation portion;
output a feedback voltage to the control portion derived from the output voltage; and
output a feedback voltage to the voltage regulation portion derived from the output voltage.

The feedback voltages which the feedback divider portion outputs to the control portion and the voltage regulation portion respectively may be the same, or they may be different to one another. In some embodiments, when the feedback divider is switched on, the feedback divider is configured to output a feedback voltage to the control portion which is higher than the received output voltage of the voltage regulation portion. In embodiments where this is the case, when the feedback divider is switched on, the comparator in the control circuit portion would output a signal indicating that the output voltage from the regulation circuitry has dipped below the reference voltage when the output voltage is a small amount lower, e.g. 40 mV lower, than the reference voltage.

The control circuitry may be configured to switch the feedback divider portion on continuously when the voltage regulation portion is in the regulation mode, and to switch the feedback divider portion to a passive state in which it acts as a sampled capacitive divider when the voltage regulation portion is in the bypass mode. The sampling may be carried out by a low frequency—e.g. 1 kHz—clock. The control circuitry may be configured to switch the feedback divider portion into the passive state when the voltage regulation portion is in the idle mode. Advantageously, when the reference voltage corresponds to the predetermined regulated voltage, switching the feedback divider in such a manner creates a hysteresis in the control mechanism. For example, this avoids the voltage regulation circuitry being switched into the bypass mode prematurely, and immediately having to then be switched back to a regulation mode if the output voltage of the voltage regulation circuitry rises above the predetermined regulated voltage again.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a graph comparing the input voltage to the output voltage of a typical LDO voltage regulator;

FIG. 2 is a simplified schematic diagram of the voltage regulation circuitry in accordance with an embodiment of the invention;

FIG. 3 is a flow diagram showing the control logic implemented by the digital logic core to switch the voltage regulation circuitry between different operational modes in accordance with an embodiment of the invention;

FIG. 4 is a graph comparing the input voltage to the output voltage of the voltage regulation circuitry in accordance with an embodiment of the invention; and

FIG. 5 is a circuit diagram showing an implementation of a voltage regulation portion of an embodiment of the voltage regulation circuitry in accordance with the invention.

### DETAILED DESCRIPTION

The voltage regulation circuitry described herein is designed to provide a regulated power domain implemented as part of a system-on-chip (SOC). Portions of circuitry in a system-on-chip may operate better at a lower voltage than the voltage which can be supplied by the power supply of the SOC. This may be because the circuit components are rated at a lower voltage than is provided by the power supply, or because exposing the circuit components to voltages at the upper end of the rated voltage range can cause premature ageing of the components.

Linear voltage regulators are typically used to generate a regulated voltage from a DC input supply voltage. One type of linear DC voltage regulator is a low-dropout (LDO) voltage regulator. LDO voltage regulators are capable of operating with very low input-output differential voltages. The advantages of such regulators with respect to other types of voltage regulators include having a lower minimum operating voltage, higher power efficiency and lower heat dissipation.

In accordance with the invention described herein, an LDO voltage regulator is configured to directly receive the input voltage from a power supply of the system-on-chip, and regulate the voltage level down to a predetermined level. The output of the voltage regulator therefore provides a regulated power domain at a lower voltage than the input supply voltage, which can be used by other portions of circuitry on the chip. Circuit components other than the voltage regulator itself can therefore be protected from being exposed to undesirably high voltages.

A conventional LDO voltage regulator consists of an error amplifier and a pass field-effect-transistor (pass-FET). The error amplifier compares the output voltage (or a voltage derived therefrom) being generated by the LDO to a reference voltage and alters the conductivity of the pass-FET in order to drive the output voltage to the desired value.

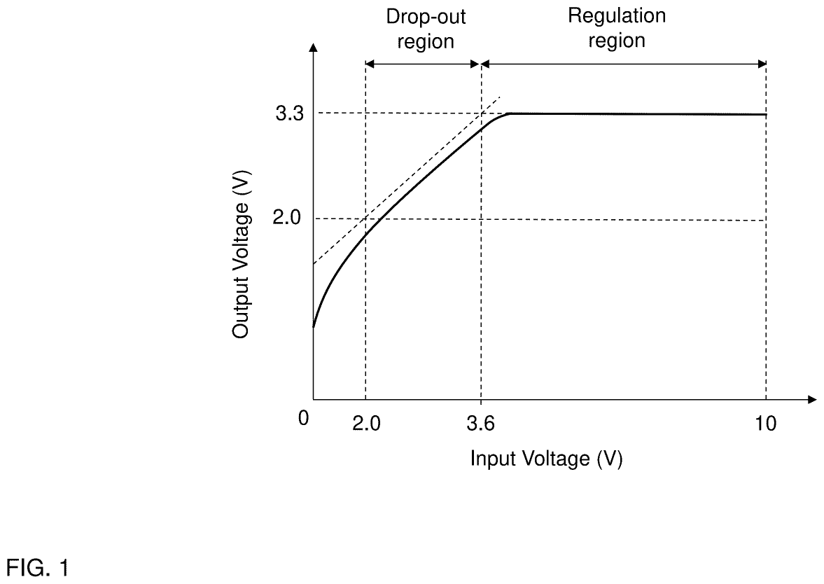

FIG. 1 is a graph comparing in general terms the input voltage to the output voltage of a typical LDO voltage regulator. When the input voltage exceeds the reference voltage, the output voltage is regulated down to a predetermined regulated level. This predetermined regulated level is 3.3V in the example shown in FIG. 1. When the supply input voltage does not exceed the reference voltage, the voltage regulator outputs a voltage equal to V_{IN}-V_{DROP_OUT}, where the drop-out voltage is a property of the regulator circuit. Drop-out voltages are typically in the order of 0.1 mV-2V, and may vary depending on the input voltage and the load on the output of the voltage regulator. In the drop-out region, the pass-FET in the LDO voltage regulator effectively operates as a resistor.

Linear DC voltage regulators, including LDO voltage regulators, dissipate power, and therefore heat, in order to regulate the output voltage, including in the drop-out region. The Applicant has appreciated that it would be beneficial not to use a regulator component when the input supply voltage is lower than the predetermined regulated voltage, i.e. when the voltage regulator is not required. This may be especially applicable if the DC power supply is generated by one or more cells in a battery. As the battery loses charge, the voltage output from the power supply will continue to decrease, until eventually the voltage output is lower than the predetermined regulated voltage needed for the rest of the chip. At this point, continuing to regulate the voltage consumes power unnecessarily.

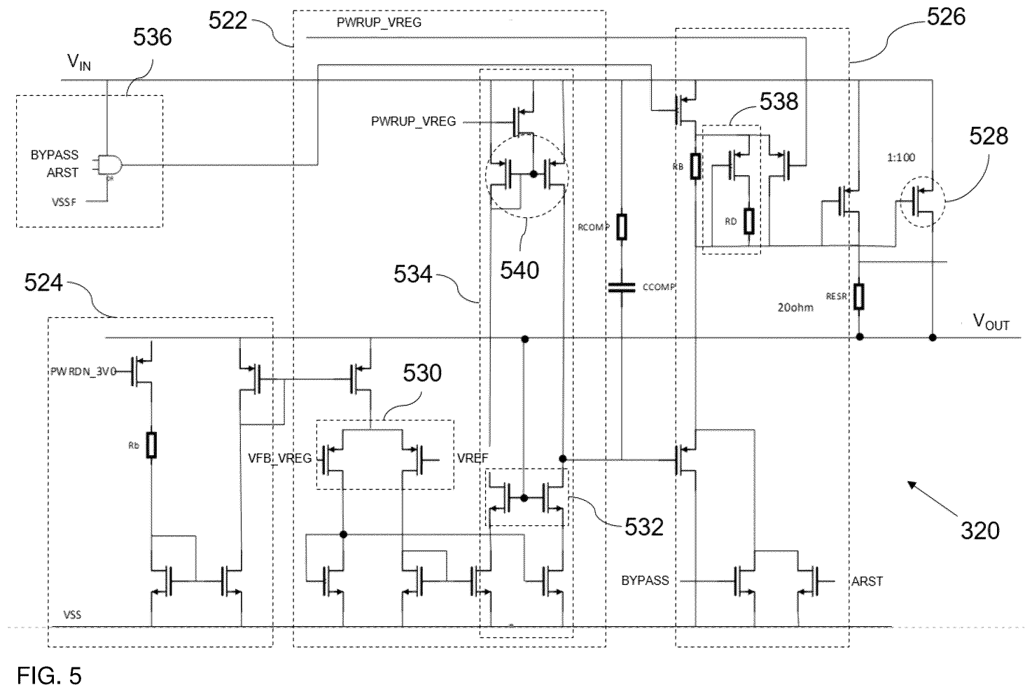

The voltage regulation circuitry described in detail herein with reference to FIG. 5 includes a voltage regulator component which operates in a similar manner to a typical LDO voltage regulator, and also includes control circuitry which can switch the regulation circuitry into a “bypass mode”. In this “bypass mode”, the voltage regulator component in the regulation circuitry is not powered on, and the output of the power supply is bypassed directly to the output of the voltage regulation circuitry.

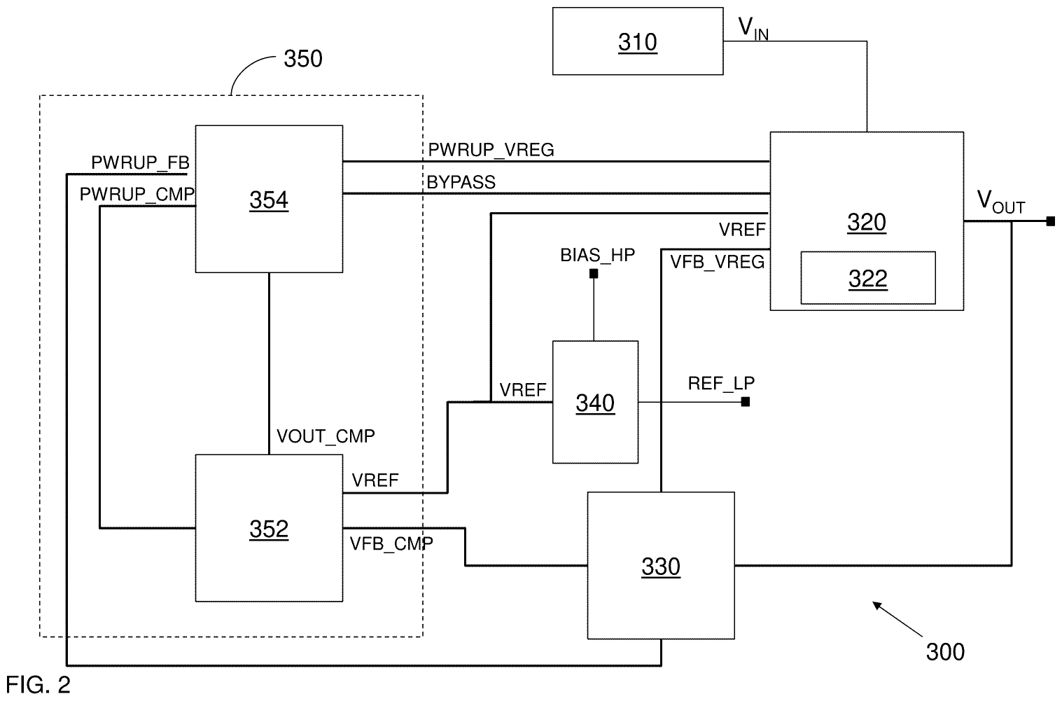

FIG. 2 is a simplified schematic diagram of voltage regulation circuitry 300, embodying the invention which forms part of an SOC. A power supply 310 outputs a supply voltage V_{IN} to a voltage regulation portion 320. The voltage regulation portion 320 in turn provides an output voltage V_{OUT}, which can be used by other portions of circuitry in the system-on-chip.

A feedback divider 330 receives the output voltage V_{OUT}, and generates two feedback voltages VFB_VREG and VFB_CMP based on the output voltage V_{OUT}. VFB_VREG is provided to a voltage regulator component 322 (connections not shown) in the voltage regulation portion 320, and VFB_VCMP is provided to a comparator 352 in a control circuitry portion 350 of the voltage regulation circuitry 300.

A reference generator 340 outputs a predetermined reference voltage VREF to both the voltage regulator component 322, and the comparator 352. The reference voltage VREF is designed to correspond to the maximum output voltage which the voltage regulation circuitry 320 should provide, i.e. the desired regulated voltage.

The comparator 352 outputs a signal VOUT_CMP to a digital logic core 354 in the control circuitry portion 350, based on a comparison between VREF and VFB_CMP.

The digital logic core 354 outputs control signals to the rest of the voltage regulation circuitry 300. Only four control signals (PWRUP_FB; PWRUP_CMP, PWRUP_VREG and BYPASS) are shown in FIG. 2, although more control signals may be implemented by the digital logic core 354 in practice. The control signal PWRUP_FB switches the feedback divider 330 on or off, and the control signal PWRUP_CMP switches the comparator 352 on or off.

The other two control signals, PWRUP_VREG and BYPASS, are provided to the voltage regulation portion 320. Once again, in practice, more control signals may be provided. There may also be intermediate circuitry for converting the control signals from the digital logic core 354, operating in the regulated power domain, to the unregulated power domain. The control signal PWRUP_VREG switches the voltage regulator component 322 on or off, and the control signal BYPASS controls the voltage regulation portion 320 to allow the supply voltage V_{IN} to be passed directly through to the output of the voltage regulation portion 320.

The digital logic core 354 controls the operation of the voltage regulation circuitry 300 using the control signals, such that it automatically switches the voltage regulation circuitry into the bypass mode when the output voltage V_{OUT} of the voltage regulation portion 320 falls below a predetermined regulated level. The comparator 352 switches its output signal VOUT_CMP between a low state and a high state in dependence on a comparison between the reference signal VREF and the feedback voltage VFB_CMP. For example, VOUT_CMP switches to a low state when VFB_CMP falls below VREF. When the output of the comparator 352 switches to a low state, the digital logic core 354 outputs control signals to switch the voltage regulation portion 320 into the bypass mode by switching PWRUP_VREG to a low state, and switching BYPASS to a high state. These control signals have the effect of switching the voltage regulator component 322 off, and connecting the supply voltage V_{IN} to the output voltage V_{OUT} respectively.

The digital logic core 354 also controls the operation of the voltage regulation circuitry 300 so that it automatically switches back into a regulation mode when the output voltage V_{OUT} of the voltage regulation potion 320 rises above a predetermined regulated level. When the output of the comparator 352 switches to a high state, the digital logic core 354 outputs control signals to switch the voltage regulation portion 320 into a regulation mode by switching BYPASS to a low state, and PWRUP_VREG to a high state.

The feedback voltage VFB_CMP is generated by the feedback divider 330 based on the output voltage V_{OUT} of the voltage regulation portion 320. The feedback divider can be used to effectively add a hysteresis to the system by adding a small amount of extra voltage to the output voltage V_{OUT} in order to generate VFB_CMP, ensuring that the output of the comparator 352 doesn't trigger until the output voltage V_{OUT} has fallen below VREF by a significant enough margin. A different feedback voltage VFB_VREG is provided to the voltage regulator component 322 in the voltage regulation portion 320, serving the purpose of the feedback voltage in the operation of a typical linear voltage regulator.

As will be described in further detail below, the voltage regulation circuitry 300 can operate in a low-power regulation mode or a high-power regulation mode.

The reference generator 340 can generate the predetermined reference voltage VREF using different sources and biasing currents from the system-on-chip depending on the power mode of operation of the voltage regulation circuitry 300. The reference generator 340 uses always-on references (REF_LP) from the system on chip to generate VREF when the voltage regulation circuitry is operating in the low-power mode, but uses a different bias current (BIAS_HP) when the voltage regulation circuitry is operating in a high-power mode. The chip may be in high-power mode when, for example, the high-frequency clock is running.

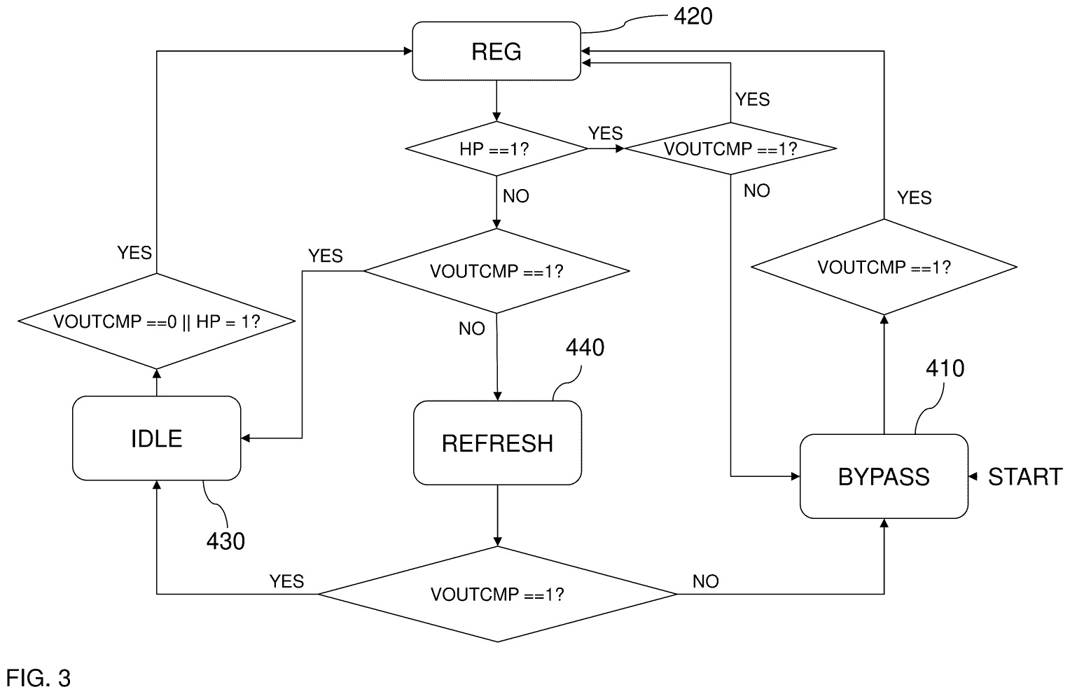

FIG. 3 is a flow diagram, which shows the control logic implemented by the digital logic core 354 to switch the voltage regulation circuitry 300 between the different states which the voltage regulation circuitry 300 can have. These states are used by the control logic to implement the bypass mode, low-power regulation mode, and the high-power regulation mode. The different states shown in FIG. 3 are a bypass state 410, a regulating state 420, an idle state 430 and a refresh state 440. The idle state 430 and the refresh state 440 are used in the low-power regulation mode, and the bypass state 410 is only used in the bypass mode. The regulating state 420 is used for both the low-power regulation mode and the high-power regulation mode.

When the voltage regulation circuitry 300 is in the bypass state 410, the voltage regulator component 322 is shut down, and the supply voltage V_{IN} is passed through to the output V_{OUT} of the voltage regulation portion 320. All regulation circuitry components are turned off, except the comparator 352. Current consumption in the bypass state is therefore minimal (e.g. as low as 60 nA).

In regulating state 420, the voltage regulator component 322 is switched on, and operates as a conventional LDO voltage regulator.

When the voltage regulation circuitry 300 is in a high-power mode, in the regulating state 420 the reference voltage generator 340 uses a biasing current (BIAS_HP) which is only available when other high-power circuit components on the chip are active to generate the reference voltage VREF. This reference voltage is then used by the voltage regulator component 322 to regulate the input voltage V_{IN} from the power supply. The voltage regulation circuitry 300 may be operating in a high-power mode when, for example, the high-frequency (HF) clock of the chip is powered on, the Buck converter of the chip has switched to a pulse-width-modulation mode, or another high-power request has been invoked. The HF clock is required by both CPU, radio and other high-power consumers in the system-on-chip. The high-power mode provides more accurate voltage regulation, better transient behaviour, lower noise and ˜3× more output current. In the high-power mode, the load current rating of the voltage regulation circuitry 300 is 90 mA, and the voltage regulator component 322 can typically consume 50 uA.

The low-power mode of the voltage regulation circuitry 300 uses two further states other than the regulating state 420: the idle state 430 and the refresh state 440. In the idle state 430, the voltage regulator component 322 is switched off, and there is no bypass enabled in the voltage regulation portion 320. Therefore, the output voltage V_{OUT} of the voltage regulation portion 320 will slowly decrease over time whilst the idle state 430 is invoked. In the refresh state 440, the voltage regulator component 322 is held in a regulating mode for a predetermined amount of time to increase the magnitude of the output voltage V_{OUT} above the predetermined regulated voltage, before being switched back to the regulator idle state 430. Due to the refresh implemented by this cycling between the idle state 430 and the refresh state 440, the output voltage V_{OUT} of the voltage regulation portion 320 will ripple around the predetermined regulation voltage level.

In the low-power mode, at the operation point where the input voltage V_{IN} from the power supply 310 is equal to the predetermined regulation voltage (i.e. at 2.6V), the drop-out voltage across the voltage regulator component 322 is designed to be less than 100 mV. The reference voltage VREF generated by the reference generator 340 during the low-power mode is generated from references which are always on from the rest of the chip. In this low-power regulation mode, the voltage regulator component 322 typically consumes 50 nA, and the maximum load current is 30 mA, including 10 mA to external circuitry.

The transition between the different modes and states of operation is described in more detail below.

When the system-on-chip is starting up, the voltage references and bias currents used by the comparator 320, the voltage regulation component 322, and reference generator 340, are not yet available. Therefore, the voltage regulation circuitry 300 would not be able to operate effectively in the regulation mode. Therefore, on start-up, the voltage regulation circuitry 300 is in the bypass state 410. The output voltage V_{OUT} of the voltage regulation portion 320 may be momentarily as high as 3.6V (i.e. the maximum that can be delivered by the power supply), but this is acceptable because the bypass state 410 is only invoked on start-up for a very short period of time (e.g. up to 1 ms).

After starting in the bypass state 410, the voltage regulation circuitry 300 is switched into the regulating state 420 after a predetermined period of time.

As explained above, if the system-on-chip is using a high-power component, the voltage regulation circuitry operates in the high-power regulation mode.

When in the regulation state 420, if the voltage regulation circuitry 300 is operating in the high-power regulation mode (HP==1), when the output of the comparator 352 indicates that the output voltage V_{OUT} of the voltage regulation portion 320 is greater than or equal to the predetermined regulation voltage (VOUTCMP==1), the voltage regulation circuitry 300 remains in the regulating state 420. Else, when the output voltage comparator indicates that the output voltage has dipped below the predetermined regulation voltage (VOUTCMP==0), the digital logic core 354 shuts down the voltage regulator component 322, and switches the voltage regulation circuitry 300 to the bypass state 410.

If the voltage regulation circuitry 300 is not in the high-power regulation mode (HP==0), when the output of the comparator 352 indicates that the output voltage V_{OUT} of the voltage regulation portion 320 is greater than or equal to the predetermined regulation voltage (VOUTCMP==1), the voltage regulation circuitry 300 is switched to the idle state 430. Else, when the output of the comparator 352 indicates that the output voltage V_{OUT} of the voltage regulation portion 320 is less than the predetermined regulation voltage (VOUTCMP==0), the voltage regulation circuitry 300 is switched to the refresh state 440 for a short, predetermined time period.

At the end of this predetermined time period, if the output voltage V_{OUT} of the voltage regulation portion 320 is greater than the predetermined regulation voltage (VOUTCMP==1), the voltage regulation circuitry 300 is switched to the idle state 430. This is expected when V_{IN} from the power supply 310 is greater than the predetermined regulation voltage level (i.e. is greater than 2.6V). If, instead, the output of the comparator indicates that the output voltage has not recovered to be higher than the comparator reference voltage following the refresh cycle (VOUTCMP==0) the voltage regulation circuitry 300 is switched to the bypass state 410. This scenario is expected when V_{IN} from the power supply 310 has dropped below the predetermined regulation voltage level (i.e. is lower than 2.6V).

When the voltage regulation circuitry 300 is in the idle state 430 and the chip starts operating in high-power mode (HP==1), the voltage regulation circuitry switches to the regulating state 420.

When the voltage regulation circuitry 300 is in the idle state 430 and remains in low-power regulation mode, when the output voltage V_{OUT} of the voltage regulation portion 320 falls below the predetermined regulation voltage, a refresh of the output voltage V_{OUT} is initiated by switching the voltage regulation circuitry 300 to the regulating state 420, then subsequently into the refresh state 440. At the end of the refresh timer, the voltage regulation circuitry is either switched into bypass mode or back into idle mode as described above.

In the regulating state 420 and the refresh state 440, the feedback divider 330 is switched on. The feedback divider 330 operates such that when it is switched on, it generates a feedback voltage VFB_CMP which is supplied to the comparator 352 that is approximately 40 mV higher than the output voltage V_{OUT} of the voltage regulation portion 320. Thus, in the regulating state 420 and the refresh state 440, the comparator 352 will only switch to a low state, and trigger switching to the bypass state, when the voltage output V_{OUT} of the voltage regulation portion 320 is 40 mV lower than the predetermined regulation voltage.

This avoids the voltage regulation circuitry 300 being switched into the bypass state 410 prematurely, and immediately having to then be switched back to the regulation mode 420 if the output voltage V_{OUT} of the voltage regulation portion 320 rises above the predetermined regulation voltage again.

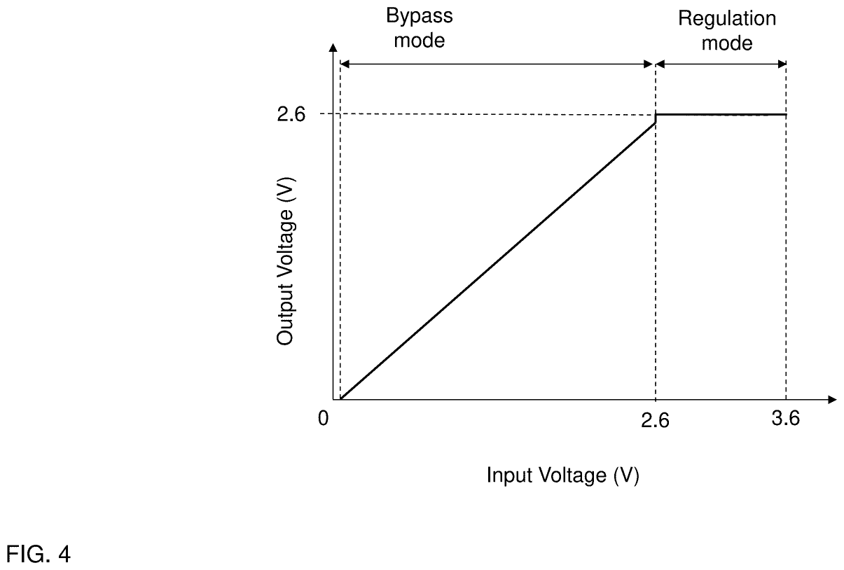

FIG. 4 is a graph showing the approximate output voltage of the voltage regulation circuitry described herein for different input voltages. The designed regulated output voltage in this example is 2.6V. The voltage regulation circuitry operates in a similar manner to a typical linear voltage regulator in regulation mode, where the output voltage is regulated down to the predetermined regulated voltage of 2.6V. However, when the input voltage dips below 2.6V, instead of the output voltage of the voltage regulation circuitry being supplied by the voltage regulator component operating in the drop-out region, the control circuitry switches the regulation circuitry into bypass mode.

The voltage regulation circuitry can therefore consume less power than a voltage regulator component which is always powered-on, and as a result, as shown in FIG. 2, the output voltage of the regulation circuitry may not exhibit the same degree of drop-out voltage. Although there is a small degree of voltage difference, this is not greater than 0.1V.

FIG. 5 is a circuit diagram showing the voltage regulation portion 320 in more detail. The voltage regulation portion 320 has an error amplifier portion 522, a resistor-driven current mirror biasing circuit 524, a gate-drive circuit 526 and a pass transistor 528. A portion of input control logic 536 is also shown in FIG. 5.

Most of the components of the voltage regulation portion 320, including the biasing circuit 524, are designed to operate in the regulated power domain, i.e. they are powered from V_{OUT}. However, the output branch 534 of the error amplifier portion 522, the gate-drive circuit 526 and the pass transistor 528 are powered in the high-voltage domain from the power supply, i.e. powered from V_{IN}. The Applicant has appreciated that aging of the components is a concern in the unregulated voltage domain, so the structures are designed to use cascading wherever possible.

The error amplifier 522 has a pMOS input pair 530 for receiving the feedback voltage VFB_VREG and reference voltage VREF (e.g. from the feedback divider 330 and the reference voltage generator 340 respectively as described above with reference to FIG. 2).

The error amplifier 522 has a conventional operational transconductance amplifier (OTA) push-pull output stage 534 including a PMOS mirror 540 to form a complete push-pull OTA. The output stage 534 is supplied by the high-voltage domain, but the nMOS transistors 532 of the output stage are cascoded from the regulated voltage supply V_{OUT}.

The gate-drive circuit 526 is a pMOS source-follower circuit, loaded by the combination of the resistor R_{B} and the diode-connected pMOS transistor 538.

The voltage regulation portion of circuitry 320 shown in FIG. 5 is controlled by the input control signals BYPASS and PWRUP_VREG (as previously described with reference to FIG. 2). When the BYPASS control signal is set (e.g. by the digital logic core 354), the gate of the pass transistor 528 is driven to ground in order to bypass the voltage from the power supply V_{IN} to the voltage regulation circuitry output V_{OUT}. When the PWRUP_VREG control signal is set (e.g. by the digital logic core 354), the core regulator component (i.e. the error amplifier 522 and the gate drive circuit 526) is switched on. A further control signal ARST is shown in FIG. 5, which is used as a control signal when an analog reset has occurred. Setting ARST has the same effect as setting the voltage regulation circuitry 300 to bypass mode. As discussed above with reference to FIG. 3, the voltage regulation circuitry 300 starts in a bypass state 410 upon start-up in order to turn the other circuit components on (e.g. the comparator 352).

The input control signals BYPASS and ARST are implemented in both the regulated power domain and the unregulated power domain. As can be seen in FIG. 5, components in the input control logic 536 are powered from the unregulated voltage supply. A floating ground VSSF is therefore implemented in order to protect the components in the input control logic 536 from being exposed to voltages which would cause premature ageing.

For the control signals originating from this input control logic 536, the logic-high voltage level is the same as the unregulated voltage supply. However, the components are protected from being exposed to a voltage difference equal to the full unregulated voltage by changing the logic-low voltage level. The logic-low voltage level is elevated some hundreds of mV above ground when the regulator is operating (i.e. when the supply voltage is greater than the desired regulation level), and dropped back to 0V when the regulator is in BYPASS mode (i.e. when the supply voltage is less than the desired regulation level, and therefore safe to expose the logic components to).

It will be appreciated by those skilled in the art that the invention has been illustrated by describing one or more specific embodiments thereof, but is not limited to these embodiments; many variations and modifications are possible, within the scope of the accompanying claims.

1. Voltage regulation circuitry comprising:
a voltage regulation portion having a regulation mode and a bypass mode, and being configured:
when the voltage regulation portion is in the bypass mode, to output an unregulated voltage received from a power supply; and
when the voltage regulation portion is in the regulation mode and the received unregulated voltage is greater than a received reference voltage, to regulate the unregulated voltage to output a predetermined regulated voltage; and
the voltage regulation circuitry further comprising a control portion configured to:
compare a feedback voltage based on the output from the voltage regulation portion to a reference voltage; and
when the voltage regulation portion is in the regulation mode, in response to determining that the feedback voltage does not exceed the reference voltage, switch the voltage regulation portion into the bypass mode.

2. The voltage regulation circuitry of claim 1, wherein the control circuitry is configured, when the voltage regulation portion is in bypass mode, in response to determining that the feedback voltage exceeds the reference voltage, to switch the voltage regulation portion into the regulation mode.

3. The voltage regulation circuitry of claim 1, wherein the voltage regulation portion has an idle mode, and the voltage regulation portion is configured, when the voltage regulation portion is in the idle mode, such that no power is provided to the voltage regulator, and the unregulated voltage received from the power supply is not passed through to the output of the voltage regulation portion.

4. The voltage regulation circuitry of claim 3, wherein the control circuitry is configured, when the voltage regulation portion is in the idle mode, in response to determining that the feedback voltage does not exceed the reference voltage, to switch the voltage regulation portion into the regulation mode.

5. The voltage regulation circuitry of claim 3, wherein the control circuitry is configured to keep the voltage regulation portion in the regulation mode for a predetermined period of time after switching the voltage regulation portion into the regulation mode from the idle mode.

6. The voltage regulation circuitry of claim 3, wherein the control circuitry is configured to, when the voltage regulation circuitry is in a low-power mode and the voltage regulation portion is in the regulation mode:
in response to determining that the feedback voltage exceeds the reference voltage, switch the voltage regulation circuitry into the idle mode.

7. The voltage regulation circuitry of claim 1, wherein the voltage regulation circuitry comprises a reference voltage generator portion, and wherein the reference voltage generator portion is configured:
when the voltage regulation circuitry is operating in a high-power mode, to output a reference voltage using a high-power current source; and
when the voltage regulation circuitry is operating in a low-power mode, to output a reference voltage using a low-power current source.

8. The voltage regulation circuitry of claim 1, wherein the voltage regulation circuitry comprises a feedback divider portion, and wherein the feedback divider portion is configured to:
receive the output voltage of the voltage regulation portion;
output a feedback voltage to the control portion derived from the output voltage; and
output a feedback voltage to the voltage regulation portion derived from the output voltage.

9. The voltage regulation circuitry of claim 8, wherein when the feedback divider is switched on, the feedback divider is configured to output a feedback voltage to the control portion which is higher than the received output voltage of the voltage regulation portion.

10. The voltage regulation circuitry of claim 1, wherein the voltage regulation circuitry is provided as part of an integrated circuit on a system-on-chip.

11. The voltage regulation circuitry of claim 10, wherein the voltage regulation circuitry is configured to start in the bypass mode when the system-on-chip undergoes an analog reset.

12. The voltage regulation circuitry of claim 11, wherein the control circuitry is configured, when the voltage regulation circuitry is in the bypass mode following the analog reset of the system-on-chip, to switch the voltage regulation portion to the regulation mode after a predetermined time period has elapsed since the reset.

13. The voltage regulation circuitry of claim 10, wherein the voltage regulation circuitry is configured to operate in a high-power mode when the high-frequency digital clock of the system-on-chip is running, and otherwise run in a low-power mode.

14. A method of voltage regulation comprising:
using a voltage regulation portion of circuitry to output an unregulated voltage received from a power supply when the voltage regulation portion is in a bypass mode;
when the voltage regulation portion is in a regulation mode and the received unregulated voltage is greater than a received reference voltage, using the voltage regulation portion to regulate the unregulated voltage to output a predetermined regulated voltage; and
using a control portion of circuitry to:
compare a feedback voltage based on the output from the voltage regulation portion to a reference voltage; and
when the voltage regulation portion is in the regulation mode, in response to determining that the feedback voltage does not exceed the reference voltage, switch the voltage regulator into a bypass mode.
